(19) United States
(12) Patent Application Publication
(10) Pub. No.: US 2021/0007292 A1
(43) Pub. Date: Jan. 14, 2021

(54) System, method, and apparatus for optimizing GROWING AND harvesting of CLIMBING PLANTS

(71) Applicant: Edward Scott Carlson, Delmont, PA (US)

(72) Inventor: Edward Scott Carlson, Delmont, PA (US)

(21) Appl. No.: 16/504,948

(22) Filed: Jul. 8, 2019

(51) Int. Cl. A01G 17/06; A01G 9/12; A47G 7/04

(52) U.S. Cl. CPC A01G 17/06; A01G 2017/065; A47G 7/047; A01G 9/12

(57) ABSTRACT

The present invention provides structures that maximize the use of minimal ground space or pot soil by providing a height-adjustable, outward-expanding string or net trellis. A compact kit can be assembled into a tall plant support structure which may be at least twice as wide at the top as at the base where the plants begin growing. A multiplicity of elongated flaccid cords secured adjacent the base at one end are inclined generally outward and attached at an opposing end to a suspended top horizontal frame support to help support plants as they grow generally vertically.

### CROSS REFERENCE TO RELATED APPLICATION

This patent application is related to and claims priority from U.S. Provisional Patent Application Ser. No. 62/694,485 filed Jul. 6, 2018.

### FIELD OF THE INVENTION

The present invention relates, in general, to a vertically elongated support structure for vining/climbing plants attached to or integral with a hanging basket, plant containers, or garden structure, and, more particularly, this invention relates to an improved system that provides an outward angle of growth from bottom to top that expands the growing area and volume for plants from a minimum footprint area.

### BACKGROUND ART

Prior to the conception and development of the present invention, hanging baskets and flower pots are some of the most commonly sold structures in the gardening industry. Hanging baskets, for the most part, are sold in common plastic pots that include a relatively short plastic support cord structure and the baskets typically contain non-vining flowers. Flower pots are sold in many sizes, shapes, material and colors, all designed mostly for ground level plants. What's missing and needed for both the deck and the garden is a support structure, in the form a kit, which includes both a container and an elongated outward-angled support/hanging structure for climbing/vining vegetables and flowers.

Gillespie, in U.S. Pat. No. 951,684, disclosed a fixed-height metal plant growing structure with rigid wire rods angled slightly outward from the plant pot, and with a hoop support at the upper end. There was no way to adjust the height, and it would not have been in a compact kit form that could be adapted to a multitude of pot sizes. Hamann in U.S. Pat. No. 8,272,160 discloses a vine stand that includes a wire cage which curves outward, and then back in such that at the top it has about the same or less cross sectional area as at the base. There are many obelisk or pyramid-type plant and vine growing structures that come to a point at the top, thereby offering decreasing volume as height increases. Schaible in U.S. Pat. No. 1,974,367 teaches the use of vertical strings for a vine, but they come to a point at the top. Y-shaped trellises have been use for grapes for decades, but they offer greater growth volume only near the top. Trellis designs for growing hops have been described with strictly vertical wires or twine, such as by Broughton in US 9999. Summers in U.S. Pat. No. 6,378,245 teaches a kit employing a braced T-shaped pole for supporting strictly vertical netting, and it would not be amenable to sloping in any direction. The prior art obviously is aware of the greater stability of being wider at the bottom and the challenges of sloping outward in the generally upward direction. None of the prior art teaches optimizing the use of a limited amount of ground plant area or easy picking of the vegetable product, especially from a potted plant.

### DISCLOSURE OF INVENTION

The present invention conveniently maximizes the use of a minimal foot print by providing at least four outward-sloping upwards cords or a net trellis such as to offer ever increasing volume for plant foliage with height, which is adjustable to the user's desire. A compact kit can be assembled into structures at least twice as wide at the top as at the base where the plants begin growing in soil. Flaccid reusable or disposable cords inclined generally downward and inward from the top horizontal frame support vining plants to grow generally vertically and even horizontally across the top.

In one preferred embodiment, the structure is basically a suspended hoop, and typically will have a multitude of cords extending upward and outward from a plant container.

### BRIEF DESCRIPTION OF THE DRAWINGS

FIG. 1 is a perspective view of a circular embodiment of the present invention.

FIG. 2 provides an elevation schematic view of a preferred embodiment of the present invention in a typical installation.

FIG. 3 is a perspective view of a hanging circular embodiment of the present invention.

FIG. 4 is a perspective view of an alternative circular embodiment of the present invention with rain-water management.

FIG. 5 is a plan view of an alternative configuration of the upper support frame.

FIG. 6 provides an elevation schematic view of a preferred embodiment of the present invention with added features.

FIG. 7 presents a flow diagram for an exemplary method of installing the present invention.

### BEST MODES FOR CARRYING OUT THE INVENTION

Prior to proceeding to the more detailed description of the present invention it should be noted that, for the sake of clarity and understanding, identical components which have identical functions have been identified with identical reference numerals throughout the several views illustrated in the drawing figures.

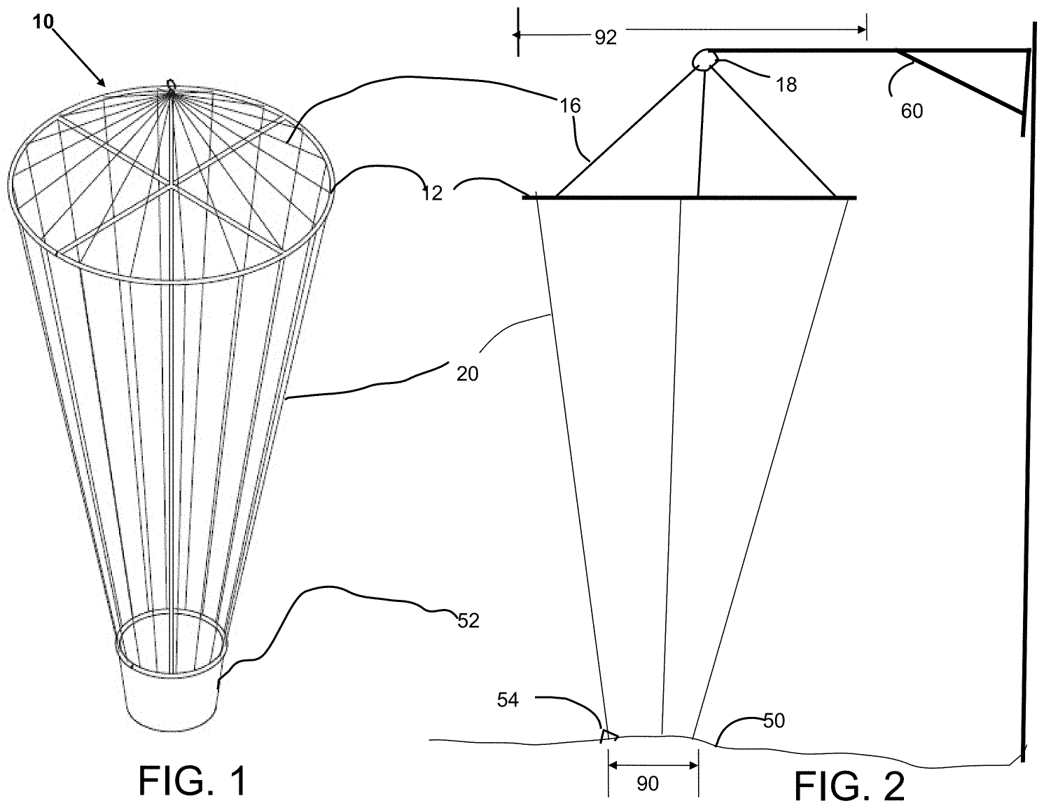

Referring initially to FIG. 1, a preferred embodiment of the present invention, shown generally as 10, is illustrated in this perspective view. The multiple elongated flaccid cords 20 slope outward and upward from the minimal plant base area of a plant container 52, or just an area of soil, and they provide the vining support for plants. By flaccid, it is meant, within the scope of the invention, that such cords are flexible yet essentially limp, not resilient, stiff, or wire-like, and not likely to get kinks. Further evidence of being “flaccid” is that upon attempting to hold any length greater than 1 cm generally vertically above the hand will result in the cord drooping downward with almost none above the hand. Climbing plants have shown an affinity to the flaccid cords of the present invention, in spite of their smooth surface. The cords may be a common gardening twine, Except for the case of suspending a basket with the cords, the preferred flaccid cords do not have a round cross section, but rather oval with an aspect ratio greater than 2. It can be rolled into a compact form and may be purchased in spools of 100 yards normally, and is often called a craft lace made of a polyolefin that is resistant to UV radiation, rain, mold, and rotting. The horizontal frame 12, a hoop, square, hexagon or any other geometry, provides the upper support for the cords 20 and the expanded width relative to the plant. It is typically suspended from a support system which typically includes a hook bracket with chains or cords 16 through a ring 18. The horizontal frame typically will be contiguous all the way around, but could have a gap, and even may be planar rigid metal coil. The number of cords will depend on the nature of the plant being grown, but will usually be at least 4, or many more as shown. The structure shown will come as a compact kit to the user.

FIG. 2 is an elevation view of a circular embodiment of the present invention very similar to that of FIG. 1. The cords 20 connect at the low end to a plant container 52, and near the top end to a horizontal frame 12. The upper horizontal frame 12 is suspended from a structure with a bracket 60 above via cords, wires, or chains 16. There are multiple ways to secure the cords near the base of the plants, such as ground pegs, staples 54, a smaller diameter hoop, or just tying to the pot rim or something in the pot. When installed, the top diameter 92 is typically at least twice that of the base diameter 90, but a wide range is encompassed as long as the ratio is greater than one.

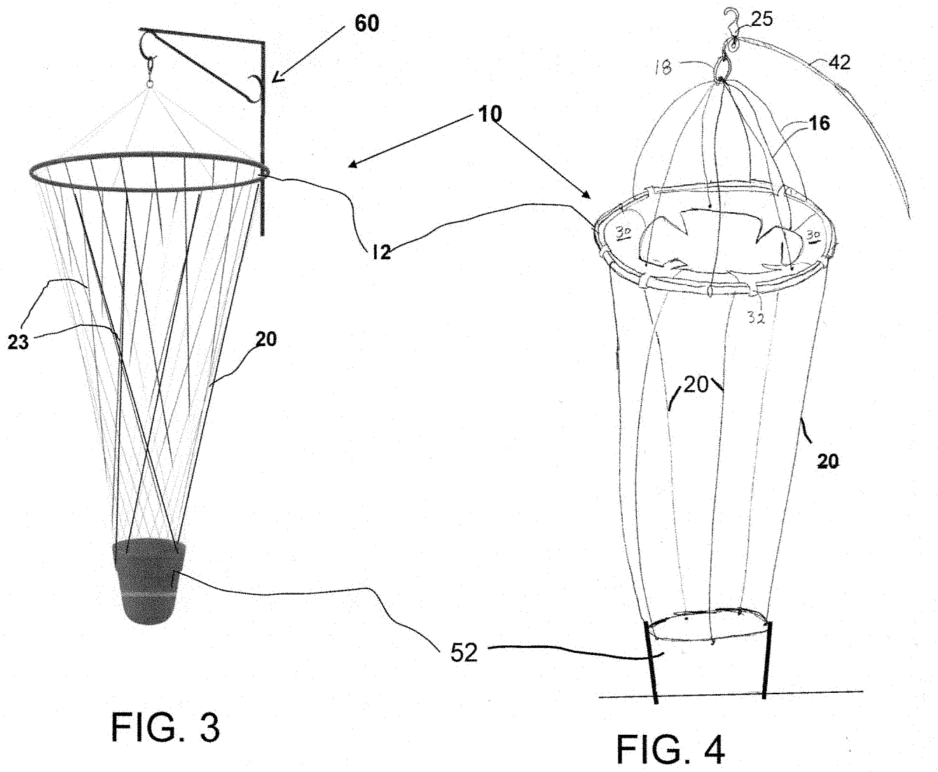

FIG. 3 is a perspective view of a hanging circular embodiment of the present invention. The upper hoop 12 is much wider than the base pot and is supported by cords or chains 16. The support system for the upper hoop may allow it to rotate, but preferably not so that when the base pot is turned about 90 degrees, the flaccid cords 20 overlap somewhat creating multiple V notches to enhance plant support.

FIG. 4 is a perspective view of an alternative circular embodiment of the present invention. In this embodiment, an inward-sloping rim flange 30 has been attached to the hoop 12 such that it can collect rainfall and drip it into the pot 52 below. This roughly triples the amount of rainwater that would fall just into the container in FIG. 1. An additional option illustrated is suspending it from the ring 18 hooked onto a rope 42 engaged with a pulley 25 such that it can be raised or lowered for maintenance or picking.

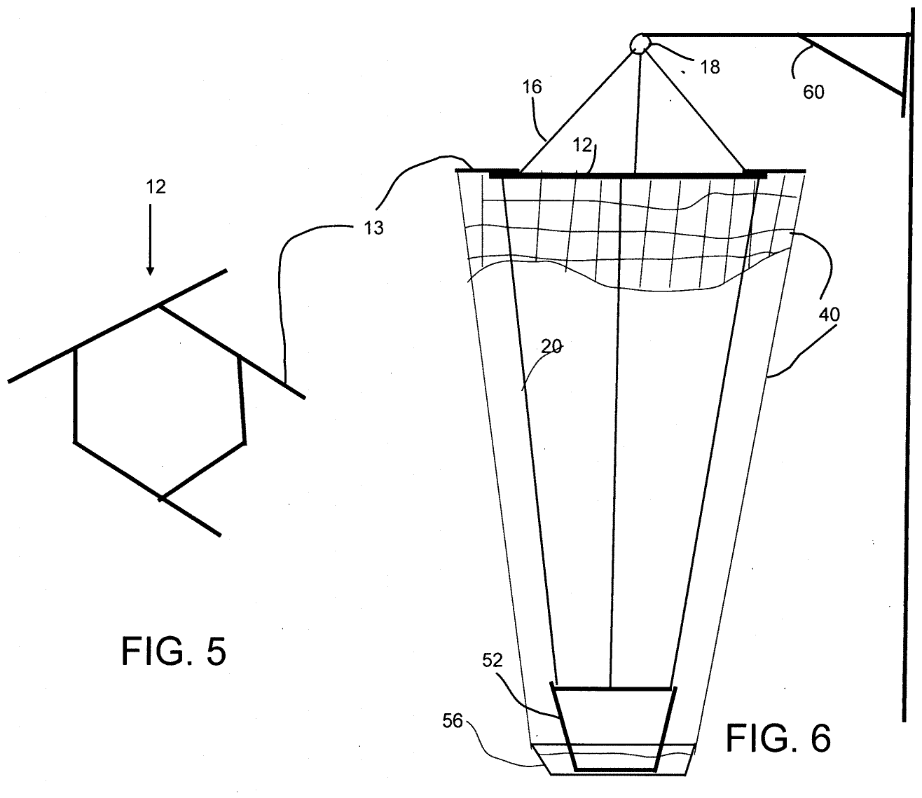

FIG. 5 is a plan view of an alternative configuration of the upper support frame 12 in a somewhat hexagonal shape. Side extensions 13 enable installing a second layer of outward-sloped cords or a net as shown in FIG. 6. The extensions 13 could either be integral with the frame or attachment thereto.

FIG. 6 provides an elevation schematic view of a preferred embodiment of the present invention with added features. With the frame extensions 13 as shown in FIG. 5, an outward-sloping net 40, shown in section, can be added for protection from animals with an outer space between it and the cords 20. The net 40 can be attached at the bottom to a water-reservoir pan 56, which has a somewhat greater diameter or width that the pot 52. With the pot 52 having a bottom or lower-side aperture, the pan 56 also serves to hold water for the plant during dry spells. There are other means for creating a space between the inner chords and the outer net.

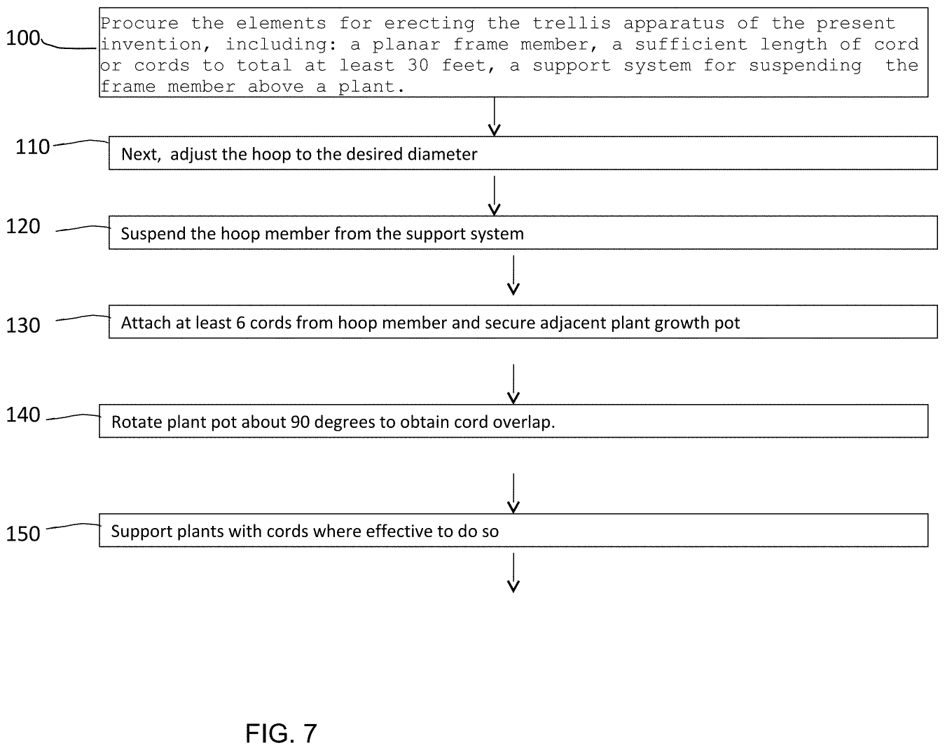

FIG. 7 presents a flow diagram for an exemplary method of installing the present invention beginning at 100 with procuring the kit. This example includes a system incorporating a typical plant pot supported on a surface. Once the elongated cords are attached top and bottom, the pot can be rotated up to 90 degrees to cause cord overlap with V notches for enhanced plant support.

While a presently preferred and alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

### INDUSTRIAL APPLICABILITY

The present invention is expected to find commercial advantage by enabling gardeners to create enhanced plant support with greater growing volume above a minimal plant area or footprint.

It is, therefore, one of the primary objects of the present invention to provide a vertical gardening system that expands volume for foliage upward, at a ratio greater than one relative to height, as plants grow up along the provided string or net trellis.

Another object of the present invention is to provide a durable, relatively inexpensive truncated cone vertical gardening system for climbing plants as well as non-vining tall plants.

Yet another object of the present invention is to provide a vertical gardening unit that facilitates harvesting of the produce.

Still another object of the present invention is to provide a trellis apparatus efficiently adaptable for growing, harvesting, and protection of vining potted plants.

An additional objective of the present invention is to provide a compact kit product that can be erected into an adjustable height outward-sloping trellis.

Yet another objective of the present invention is to provide a method for installing a string trellis such as to create V notches with the cords (strings) for enhanced plant support.

I claim:

1. A plant support trellis providing ever increasing growth volume in the vertical direction from growing medium comprising:
a) at least one frame member having one of a first predetermined diameter and width;
b) a frame support system for suspending the frame member horizontally;
c) one of a net and a multiplicity of elongated flaccid cords configured for attachment at one end adjacent the growing medium and to said support hoop at the other end.

2. The plant support trellis of claim 1 wherein said frame support system includes a ring, a bracket, and multiple connecting members between the ring and the frame.

3. The plant support trellis of claim 1 wherein said multiplicity of elongated flaccid cords is at least four.

4. The plant support trellis of claim 1 wherein said frame member is a hoop.

5. The plant support trellis of claim 1 wherein said frame member has at least four sides.

6. The plant support trellis of claim 1 wherein said support trellis further includes said net being of sufficient length to reach from the frame member to a plant below when installed.

7. A kit for erecting a plant support trellis, said kit comprising:
a. at least one planar frame member,
b. a frame support system configured for suspending said frame member horizontally; and
c. a compact supply of elongated flaccid cord with a predetermined total length.

8. The kit of claim 7 wherein said planar frame member is a hoop.

9. The kit of claim 8 wherein said hoop has an adjustable diameter.

10. A method for erecting a plant support trellis configured to provide expanding volume for growth in a vertical direction, wherein the method begins with procuring a trellis kit including: at least one planar frame member, a frame support system configured for suspending the frame member horizontally; and a compact supply of elongated flaccid cord with a predetermined total length. Subsequently, installing the frame support system in a preselected location wherein the frame member is suspended at a predetermined height above a plant growing container resting on a surface. Then installing at least six elongated flaccid cords by attaching one end to the frame member and the other to the growing container rim. Subsequently rotating the plant container about 90 degrees such as to cause some of the elongated flaccid cords to overlap.

11. The method of claim 10 wherein a protective net is also added to the frame as a cage around the cords and plant foliage.
